(19) United States
(12) Patent Application Publication
(10) Pub. No.: US 2014/0110954 A1
(43) Pub. Date: Apr. 24, 2014

(54) Deadbolt lock

(71) Applicant: John Nichol, Oshawa (CA)

(72) Inventor: John Nichol, Oshawa (CA)

(21) Appl. No.: 13/998,319

(22) Filed: Oct. 21, 2013

(30) Foreign Application Priority Data
Oct. 19, 2012 (CA) 2,793,264

(51) Int. Cl. E05C 19/00

(52) U.S. Cl. CPC E05C 19/00
USPC 292/277

(57) ABSTRACT

A lock consists of an elongated track which is attached to the panel of a door. A slider runs in the track from a retracted position in which the slider is spaced apart from the knob which operates the deadbolt to an engaged position in which the slider is in contact with the knob and prevents it from turning. The slider can be locked in that position by means of a locking pin. The pin may also be used to immobilizes the slider in the retracted position.

This Application claims priority pursuant to 35 USC 119 of Canadian application no. 2,793,264 filed on Oct. 19, 2012 the entire contents of which are hereby incorporated into the following application by reference.

### FIELD OF THE INVENTION

This invention relates to a lock for a deadbolt and more particularly to a lock which, when engaged, prevents an unauthorized entry through a door and which can only be engaged or disengaged from within the door but not from outside the door.

### BACKGROUND OF THE INVENTION

Deadbolts arc engaged by turning a key or knob on the inside of a door and are usually used in conjunction with a lock that engages by the action of a spring. The deadbolt is intended to give an additional measure of protection to occupants of a house or apartment or to their belongings. However, the locks of both a deadbolt and a spring activated lock are subject to being picked. A deadbolt lock, in particular, is usually located in an enclosure on the outside wall of a door or insert into the door and arc accessible to be picked by a potential intruder outside the door.

It is known to provide a locking device which prevents the key or knob of a deadbolt from being turned. The devices are positioned on the inside wall of a door and are accessible only to persons inside the door. U.S. Pat. No. 6,301,941 to Nicholsfigueiredo for example describes a bar which slides in a track attached to an inside wall of a door. The bar is in the shape of a yoke which engages the knob of a deadbolt and immobilizes it. The bar only does so however if the track is horizontal. If the bar extends downwardly from the knob, the yoke may slide downward and out of engagement with the knob. If the track extends upwardly from the knob, the yoke may accidently slide downward into engagement with the knob thereby making it impossible to open the door except from inside. If there is no one inside, the door may have to be broken to open it since the door cannot be opened from outside. Even if the track is horizontal the knob must fit into the yoke for the locking device to function properly and if the track shifts over time, the knob may not continue to fit into the yoke.

I have invented a lock for a deadbolt which overcomes many of the shortcomings of the lock described above. The track in which the bar travels may be oriented at any angle on a door so long as the bar when slid forward, contacts the knob. The track can accordingly be positioned so that it avoids decorative moulding or other projections on a door. Furthermore the bar can be immobilized in the track when it is not contacting the knob to prevent the bar from accidently sliding into contact with the knob.

The only way that my lock can be engaged or disengaged is by a person within the premises of a house or apartment. When properly used, the subject lock cannot engage accidently without human intervention and it cannot be engaged or disengaged by someone from outside the premises. As a result, a person cannot accidently lock himself out of a house or apartment since the subject lock can only be engaged and disengaged by him when he is inside the premises.

### SUMMARY OF THE INVENTION

Briefly, the lock of my invention includes an elongated track adapted to be attached to the inner panel of a door. A slider is disposed in the track and travels in a direction from an inoperative position in which the slider is spaced apart from the knob which activates a deadbolt to an operative position in which the slider is in contact with the knob mid prevents the knob from rotating. The lock includes immobilizing means for selectively immobilizing the slider in the track when the slider is in the operative and inoperative positions.

### DESCRIPTION OF THE DRAWINGS

The lock of the invention is described in detail with reference to the accompanying drawings in which:

FIG. 1 is an elevation of the side edge of a door in conjunction with a conventional deadbolt;

FIGS. 2a and 2b are perspective views of the lock of my invention arranged above and below, respectively, a knob for operating a deadbolt;

FIG. 3 is an enlarged perspective view of a slider and track of my lock;

FIGS. 4 and 5 are perspective views of the slider in a withdrawn and an extended position, respectively within the track;

FIG. 6 is an elevation of my lock in which the knob of a deadlock is free to turn; and

FIG. 7 is an elevation of my lock in which the knob of a deadlock is prevented from turning

Like reference characters refer to like parts throughout the description of the drawings

### DESCRIPTION OF PREFERRED EMBODIMENT

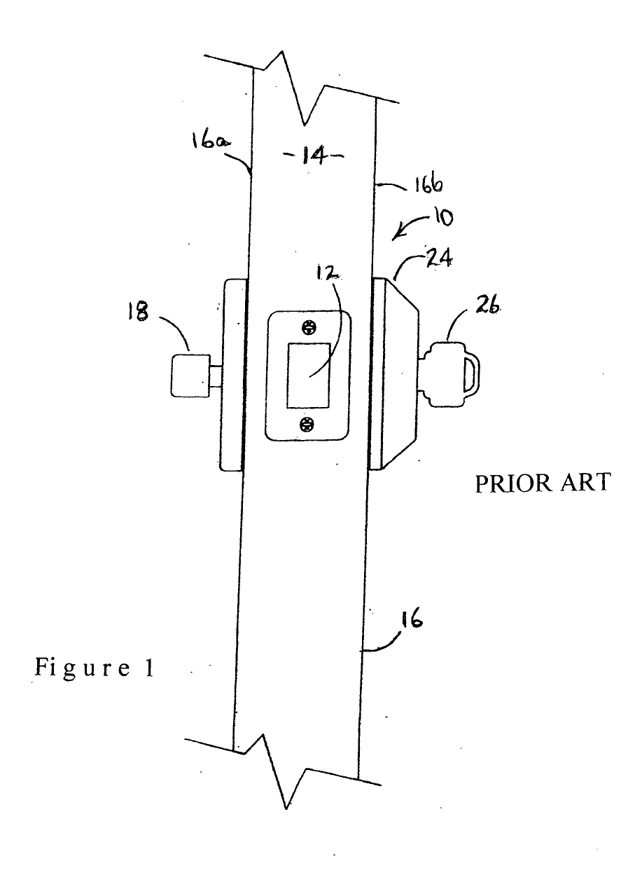

With reference to FIG. 1, a conventional deadbolt-lock generally 10 is illustrated. The lock is composed of a deadbolt 12 which extends and retracts from the side edge 14 of a door 16. Knob 18 on the inner panel 16a of the door controls the movement of the deadbolt. A mechanism for causing the deadbolt to function is within an enclosure 24 on the outer panel 16b of the door and is operated by key 26.

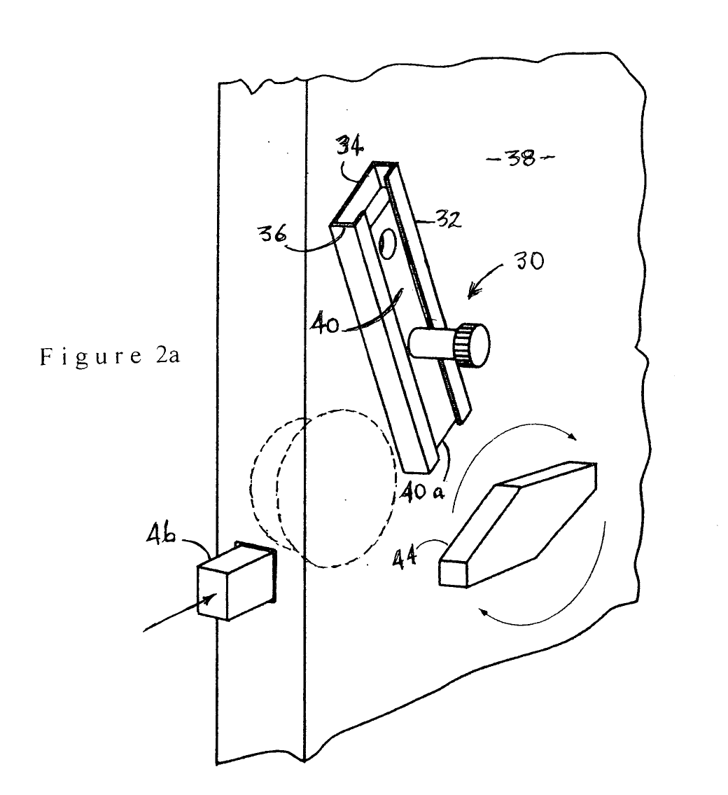

With reference to FIGS. 2a and 2b, the lock of this invention, generally 30, is composed of a track 32 having a web 34 and U-shaped flanges 36 on opposite sides of the web. The flanges function to confine a slider 40 within the flanges but permit the slider to slide longitudinally in the direction of arrow 42 in the track but not to slide laterally.

The lock is positioned on the inner panel 38 of a door which separates an interior space such as the interior of a house from an exterior space such as the outdoors.

The slider is in the form of a flat bar having a forward edge 40a which is relatively straight and is generally perpendicular to the direction of travel 42 of the slider in the track. The track is positioned such that the forward edge of the slider slides toward and away from the knob 44 which controls the movement of a conventional deadbolt 46. The forward edge need not make contact along its entire length with the knob as long as what contact there is, is sufficient to prevent the knob from rotating.

The track may be positioned on the inner panel of the door anywhere around the knob 44: such as above it, as illustrated in FIG. 2a, beneath it as illustrated in FIG. 2b or horizontally beside it. As long as the position of the track is such that the slider slides toward and away from the knob and the forward edge 44a of the slider, in its forward-most position, contacts the knob and immobilizes it, the track is properly positioned.

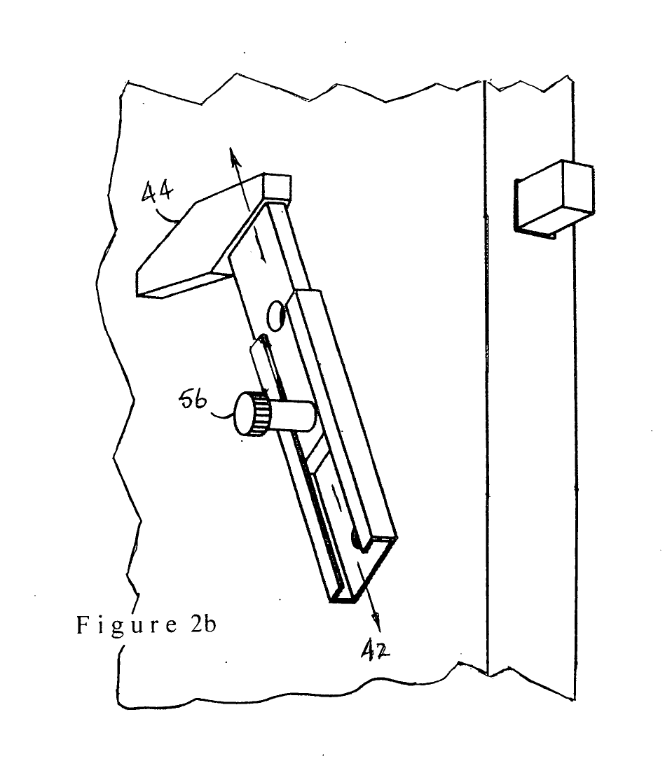

With reference to FIG. 3, the track is attached to a door by a pair of screws 50 which extend through apertures in the web of the track and into the inner panel of the door. The slider is provided with two spaced apart openings, a forward opening 52a closer to the forward edge 40a of the slider and a rear opening 50b closer to the rear edge of the slider. The openings are of equal diameter. An opening, 54 also of equal diameter, is formed in the web of the track.

When the forward edge of the slider is in contract with the knob of the deadbolt as illustrated in FIG. 2b, the rear opening 52b in the slider lines up with opening 54 in the track. When the forward edge of the slider is spaced apart from the knob of the deadbolt, as illustrated in FIG. 2a, the forward opening 52a in the slider lines up with the opening 54 in the track

Immobilizing means in the form of a locking pin 56 serves to immobilize the slider in the track when it is extends through aligned openings in the slider and the track. In FIG. 2b, the locking pin immobilizes the slider when it is in contact with the knob of the deadbolt and functions to immobilize the deadlock in an extended position to prevent the door from being opened. The slider is then in an operative position. When the locking pin is removed, the slider may be slid out of contact with the knob. The knob may then be turned to retract the deadbolt into the interior of the door. The slider is then in an inoperative position.

Locking of the knob of the deadbolt is therefore simply a matter of advancing the slider into contact with the knob of the deadbolt and immobilizing the slider hi an operative position by means of the locking pin. Unlocking the knob from an engaged position involves removing the locking pin and withdrawing the slider from the knob until the forward opening in the slider is in alignment with opening 54 in the track. The slider is then in an inoperative or withdrawn position and is im-mobilized in the track in this position by means of the locking pin. The knob may then be turned to retract or advance the deadbolt.

The locking pin may be a simple cylinder or it may be a conventional ball-locking pin having a spring activated ball 56a at its lower end as illustrated in FIG. 3. A ball-locking pin is preferred because once inserted into aligned openings in the slider and track, the pin will remain in place unless a force opposed to the bias of the spring is applied to the pin by physically pulling the pin out of the openings. The pin will accordingly not accidentally fall out of the openings.

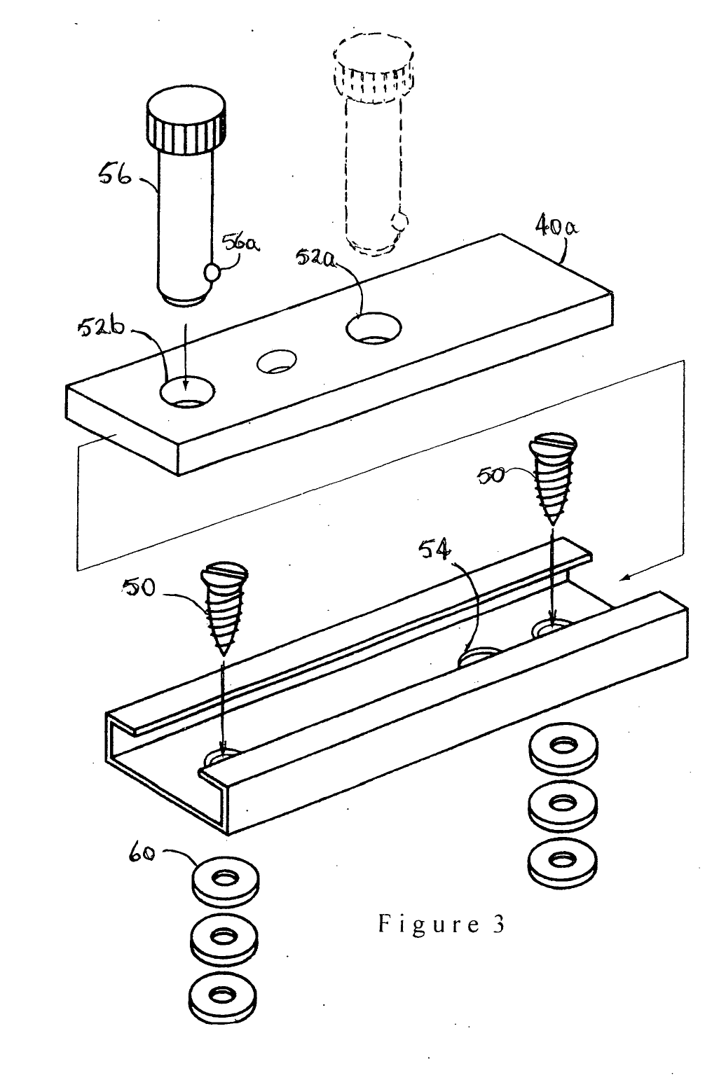

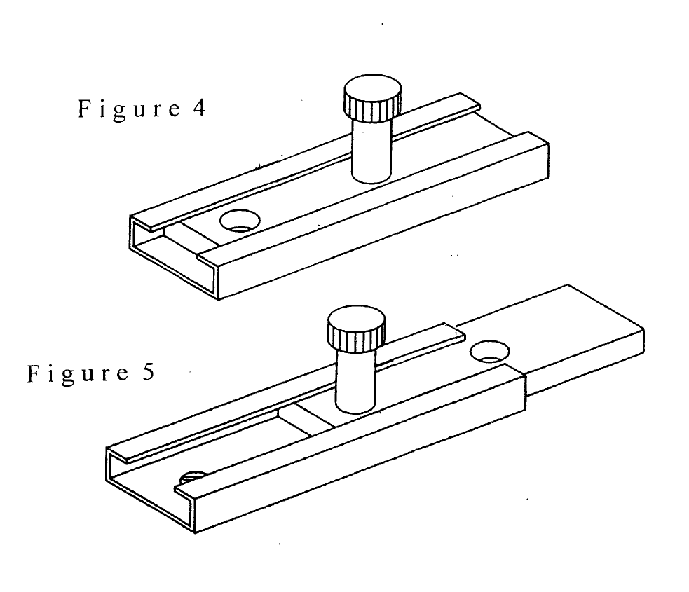

In FIG. 4 the slider is in an inoperative or withdrawn position and in FIG. 5, the slider is in an operative or extended position.

As previously indicated, the only way that the subject lock can be engaged or disengaged is by a person within the premises of a house or apartment. The subject lock cannot engage without human intervention except in one situation. If the lock is above the knob of a deadbolt and the slider is not immobilized by a locking pin, the slider may slide downward into engagement with the knob. In that case, the knob can still be turned by means of a key from outside the door. That is because if there is no locking pin to prevent the slider from moving, the knob will cause the slider to move upward so that it dues nut hinder its rotation.

Except in the above situation, the deadbolt cannot be engaged or disengaged by someone from outside the premises. As a result, a person cannot accidently lock himself out of a house or apartment since the subject lock can only be engaged and disengaged by him when he is inside the premises.

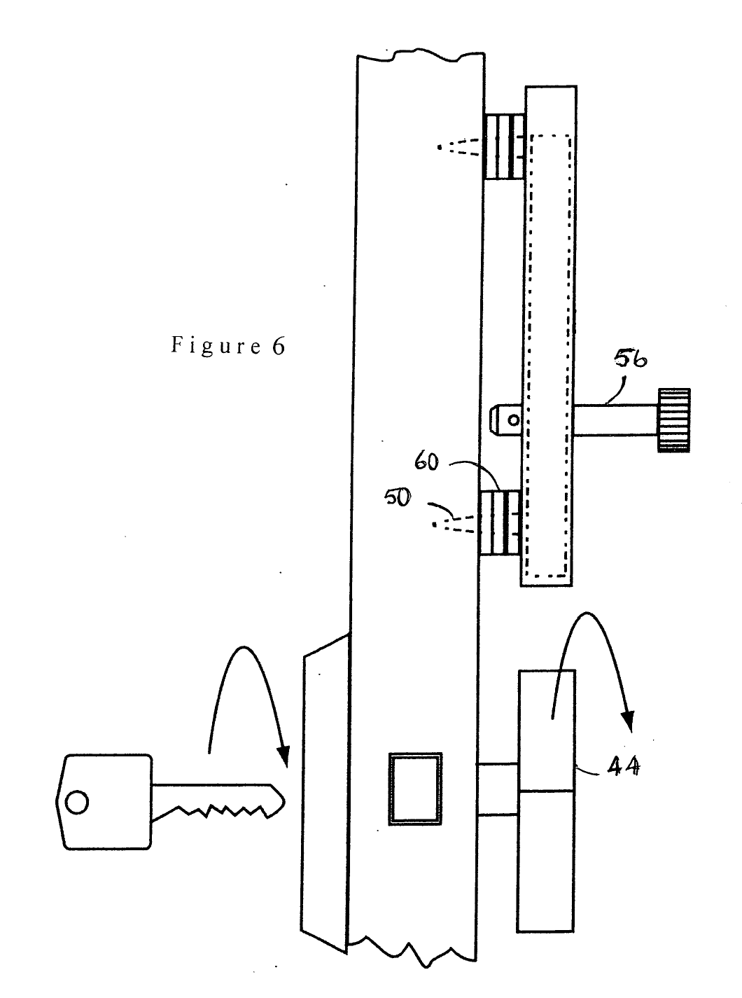

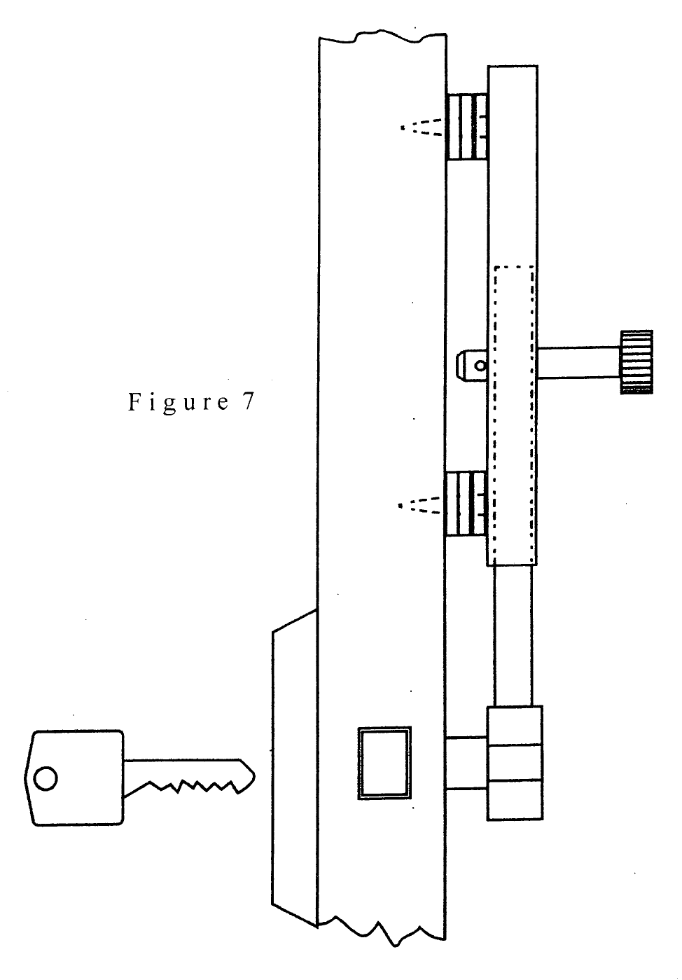

With reference to FIGS. 3, 6 and 7, the spacing between the track and the door can be adjusted by means of one or more washers 60 surrounding screws 50 which attach the track to a door. The screws allow the position of the slider to be adjusted to contact the knob of the deadbolt whether the knob is adjacent to the door or spaced apart from it. The washers also make it possible to position the track sufficiently far apart from the door to ensure that them is sufficient clearance for the spring loaded ball 56a of the locking pin to function.

It will be understood, of course, that modifications can he made in the lock of the invention without departing from the scope of the invention defined in the appended claims.

I claim

1. A lock for a deadbolt for use on a door which separates an interior space from an exterior space, said door having oppositely facing inner and outer panels, said inner panel, when said door is closed, facing said interior space while said outer panel faces said exterior space, said lock having: a deadbolt; a knob accessible front said interior space and operable by means of a key in said exterior space, said knob functioning to cause said deadbolt to selectively lock and unlock said door; an elongated track adapted to be attached to said inner panel; a slider disposed in said track and slidable from an inoperative position in which said slider is spaced apart from said knob and allows said knob to turn, to an operative position in which said slider is in contact with said knob and prevents said knob from turning, and immobilizing means for immobilizing said slider selectively in said operative position and in said inoperative position.

2. The lock of claim 1 wherein said immobilizing means is a locking pin movable in and out of openings in said track and said slider.

3. The lock of said 2 wherein said locking pin is a spring-activated ball-locking pin which, when inserted into said openings, remains in place until a force, opposed to the bias of said spring, is applied to extract said pin from said openings.

4. The lock of claim 2 wherein said pin has a stem which passes through said openings; and a spring-activated ball which extends outwardly from said stem and which is disposed beneath said openings, said ball preventing said stem from being extracted from said openings until a force, opposed to the bias of said spring, is applied to said pin to cause said stem to withdraw from said

5. The lock of claim 1 wherein said slider has a forward edge which contacts said knob in said operative position, said edge being relatively straight and disposed generally perpendicular to the direction in which said slider slides in said track.

6. The lock of claim 1 wherein said slider consists of a flat bar having a forward edge which is relatively straight and is generally perpendicular to the direction in which said slider slides in said track.

7. The lock of claim 1 further including adjusting means for adjusting the spacing of said track from said inner panel.

8. The lock of claim 7 wherein said adjusting means is one or more washers adapted to be positioned between said track and said inner panel.

9. The lock of claim 1 wherein said immobilizing means is a a spring-activated ball-locking pin which, when inserted into said openings, remains in place until a force, opposed to the bias of said spring, is applied to extract said pin from said openings and said slider consists of a flat bar having a forward edge which is relatively straight and is generally perpendicular to the direction in which said slider slides in said track.

10. The lock of claim 9 further including adjusting means for adjusting the spacing of said track from, said inner panel.

11. The lock of claim 10 wherein said adjusting means is one or more washers adapted to be positioned between said track and said inner panel.
